(19) United States
(12) Patent Application Publication
(10) Pub. No.: US 2006/0081782 A1
(43) Pub. Date: Apr. 20, 2006

(54) Remote detector system

(75) Inventors: Louis J. Guillebaud, Albuquerque, NM (US); Harry C. Majors, Santa Fe, NM (US)

Correspondence Address: PEACOCK MYERS, P.C., 201 THIRD STREET, N.W., SUITE 1340, ALBUQUERQUE, NM, 87102, US

(73) Assignee: Technology Management Consulting Services, Inc., Los Alamos, NM (US)

(21) Appl. No.: 11/067,094

(22) Filed: Feb. 25, 2005

Related U.S. Application Data
(60) Provisional application No. 60/619,855, filed on Oct. 18, 2004.

(51) Int. Cl. G01F 23/00

(52) U.S. Cl. 250/360.1

(57) ABSTRACT

A mobile detecting apparatus which can include the ability to transmit data to and receive instructions from a remote location, detect multiple objects (e.g. stacked or side by side containers or cargo), and provide efficient traffic flow (e.g. at cargo port).

### CROSS-REFERENCE TO RELATED APPLICATION

This application claims priority to and the benefit of the filing of U.S. Provisional Patent Application Ser. No. 60/619,855, entitled “Radiation Detectors”, filed on Oct. 18, 2004, and the specification thereof is incorporated herein by reference. This application is also related to utility application, entitled “Detector System”, filed on even date herewith and the specification and claims are incorporated herein by reference. This application is also related to utility application, entitled “Detector System for Traffic Lanes”, filed on even date herewith and the specification

### BACKGROUND OF THE INVENTION

1. Field of the Invention (Technical Field)

The present invention relates to detector systems. The present invention relates particularly to mobile detectors, which are preferably dimensioned for scanning multiple standard shipping containers, automated via remote communications and will accommodate traffic lanes for drive-through or walk-through applications.

2. Description of Related Art

Serious concerns over the illicit trafficking in radioactive materials from terrorist countries into the United States has led to a number of programs funded by the U.S. Government to install passive radiation and other detectors at various border crossings and inside facilities that traffic in cargo, or passengers. These detectors are fixed at locations where the cargo, mail, luggage, passengers, etc., are forced to pass in front of the detectors. In order to achieve the level of sensitivity necessary for detection of the material of interest, the detectors are relatively large and need to be positioned near the surface of the containers or persons being monitored.

While fixed detectors can provide desirable results for material that can be forced to pass through an established choke point where such a fixed detector has been permanently installed, unfortunately, many situations exist where it is unreasonable to force the items to be rerouted through a fixed detector system. Examples include containers that are being moved between ships at a harbor or luggage being moved between airplanes at an airport. Yet another example is the need for temporary monitoring during special events or at special locations. In many of these cases the requirement to re-route the material to be inspected through a set of fixed detectors is very disruptive and inefficient, thus making such monitoring impractical.

Although portable radiation detectors are known in the art, for example U.S. Pat. No. 5,330,142, to Gnau, III, they do not have the ability to raise and lower the detector in an automated fashion. Thus, the devices cannot “scan” each cargo container, particularly when such containers are stacked several containers high or arranged side-by-side. As such, the device of Gnau, III cannot be used to scan large numbers of cargo containers at places where such containers reside. Further, the device of Gnau, III, lacks the ability to transmit data to a remote and secure location, as well as to receive instructions from a remote location. This leaves an operator of the Gnau, III, device subject to influences commensurate with radioactive materials as well as with influences from people associated with trafficking in such radioactive materials.

There is thus a present need for a mobile monitoring system which uses detectors, integrated supporting systems, power supplies, and communications systems, mounted on modularized mobile structures, which structures can be quickly moved to a point where all types of cargo, items, people or animals need to be monitored. Such a mobile system would further benefit from the use of wireless communication systems, thus allowing the data to be collected in a central location along with photos or other manners of identifying items, as well as the ability to provide instructions to the mobile unit.

### BRIEF SUMMARY OF THE INVENTION

The present invention comprises an apparatus and method for arranging a plurality of objects of interest to be detected (e.g. stacked or side-by-side shipping containers or baggage on a baggage conveyor); mounting at least one movable detector on a positionable structural support; moving at least one detector into a desired position relative to the arrangement of the plurality of objects; passing the plurality of objects of interest through the structural support; and subjecting the plurality of objects of interest to detection with at least one detector.

The present invention also comprises an apparatus and method for communicating with a remote location. In this embodiment, the remote location is capable of receiving data and transmitting instructions. The positionable structural support comprising at least one detector disposed on the structural support. Data from at least one detector is transmitted to the remote location and/or instructions are transmitted from the remote location to the structural support. The structural support has an opening for passing at least one object of interest therethrough. The remove location may be in another country separate from the structural support.

The present invention further comprises a mobile detecting apparatus and method comprising a mobile and positionable structural support comprising an opening with internal dimensions sufficient to straddle at least one traffic lane. The structural support preferably does not change the traffic lane pattern. The support comprises at least one detector disposed on the structural support.

The detector(s) preferably comprise an active detector, a passive detector, or combinations thereof. Most preferably the detectors comprise at least one radiation detector. At least one detector is preferably movable vertically. At least one detector is positionable about the structural support.

The structural support preferably comprises one or more wheels and an operator station, disposed on the structural support. The operation of the structural support or detectors may be controlled from the operator station. The structural support is preferably expandable in width and/or in height.

The invention preferably further comprises a data transmitter for transmitting data to a remote location and/or a data receiver for receiving data from a remote location. Based on the data, instructions are sent to the structural support and/or the detectors. Adjustments (preferably automatic) may be made to the structural support, one or more attributes of the detectors, or combinations thereof. In one embodiment, a first detection is made and then the detector is adjusted for a new sensitivity or threshold. The instructions may enable intelligence of the structural support or the detector(s). Control of the detecting apparatus may be manual, automatic, and/or a combination of controls.

The invention is capable of accommodating one or more traffic lanes. The structural support may be move to a desired location. It may be positioned over one or more traffic lanes and preferably does not interfere with the traffic flow in that lane. The present invention may further comprise data acquisition. The data acquisition may comprise using at least one algorithm. The apparatus preferably has a turning radius of zero and one or more wheels. The apparatus may be towed and/or powered.

The present invention may comprise multiple structural supports, each support straddling an individual traffic lane.

The structural support may be movably positioned in a first location, fixed for a time at that location, and then subsequently moved by positioning it in another location.

A primary object of the present invention is to provide a mobile detector system, particularly a mobile detector system having the ability to transmit data and receive instructions from a remote and secure location and to scan multiple objects of interest or containers.

A primary advantage of the present invention is that cargo, persons and animals can be scanned at locations where they naturally reside or pass, thus negating the requirement to route such cargo, persons and/or animals through a fixed detecting station.

Another advantage of the present invention is that personnel or computers at a remote location can analyze, view or process the data supplied by the mobile detector in real time and can provide instructions to the mobile unit in real time in response to data received at the remote location.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a perspective view showing a preferred embodiment of mobile detector of the present invention;

FIGS. 2 and 3 are perspective view showing a truck passing through a multi-lane embodiment of the present invention;

FIG. 4 is a perspective view showing a preferred embodiment of mobile detector of the present invention useful for multiple containers;

FIG. 5 is a front view showing a preferred embodiment of a single lane mobile detector of the present invention;

FIG. 6 is a perspective view showing a modular assembly to expand the mobile detector system of the present invention to multi-lane applications;

FIG. 7 is a schematic representation depicting a preferred embodiment of the present invention wherein a remote location receives data from and transmits instructions to a structural platform and detector system;

FIG. 8 is a perspective view of a data acquisition station at the site of the mobile detection;

FIG. 9 is a perspective view of a mobile detector of the present invention passing over a container; and

FIG. 10 is a perspective view of the present invention used as a mobile detector for airport conveyors for baggage.

### DETAILED DESCRIPTION OF THE INVENTION

The term “wheels” as used throughout the specification and claims is intended to include any device, apparatus, element, structure, and/or combination thereof, which enables a first element to be moved across a second element, and can include, but is not limited to any type of wheels and tires, tracks, skids, etc., as well as combinations thereof.

The term “detector” as used throughout the specification and claims is intended to include any and all active and passive devices, apparatuses, and/or methods capable of detecting or inferring desired information, including but not limited to detection of light, sound, heat, odor or smell, chemical or physical substance, biological agent, shape, radiation, etc.

The term “radiation detector” as used throughout the specification and claims is intended to include any and all devices, apparatuses, and/or methods capable of detecting or inferring radioactivity, including but not limited to radiation detectors of any kind, shape or form; including scintillators, advanced discriminator plastics, sodium-iodide (Nal) detectors of any type or form or shape including cylindrical, rectangular or square cross section logs, CZT (cadmium-zinc-tellurium) detectors of any shape or form, helium-3 tubes or other detectors for neutron detection, high-resolution germanium (Ge) detectors, as well as combinations thereof.

The term “transmitting” used throughout the specification and claims is intended to include any manner, method, way and/or medium for relaying data and/or information, and includes but is not limited to wireless, wired, optical, satellite, cellular and combinations thereof.

The term “object(s) of interest”, “object(s) and “item(s)” as used throughout the specification and claims is intended to include anything or things, person or persons, or animal or animals that pass through the detector(s) of the present invention. The word “container” or “cargo” are frequently used as particular objects of interest in order to illustrate the features of the present invention, and those skilled in the art can appreciate the applicability of the present invention to other objects of interest besides containers and cargo.

The term “traffic lane(s)” or lane(s) as used throughout the specification and claims is intended to include any lane, track or pathway for a vehicle, person, animal, conveyor, object of interest, etc., and also includes any entry including but not limited to a facility, building, vehicle, etc.

The present invention comprises a uniquely positional, high-sensitivity detector system (one or more detectors) capable of deploying to virtually any location, and which can optionally be mobile and/or motorized. A preferred location for the detector system is a usual traffic choke point, rather than forcing the material or people through a choke point defined by a fixed detector location.

Depending on the detectors selected, simultaneous detection in a variety of cargo configurations is possible. For instance, one could simultaneously detect special nuclear materials (“SNM”) other hazardous radioactive isotopes of interest, and/or illicit drug contraband hidden in the container. By modularizing the arrangement of the detectors, the mobile system of the present invention accommodates a variety of stacking or side-by-side arrangements of the objects of interest.

The use of predetermined detector profiles allows improved ability to distinguish illicit material or material(s) to be detected from surrounding materials. By providing mobility, the present invention can be deployed exactly to the point of need, even when these locations change on short notice. The present invention has the ability to acquire data (or other accumulated information) emitted or derived from objects of interest passing through the detector. Data and/or information is preferably collected from at least two sides of the objects of interest, and preferably from a top portion of the objects of interest passing therethrough. The modular nature of the present invention allows monitoring from at least two sides at very close distances, thus giving radiation measurements (and/or other measurements) a high degree of sensitivity and accuracy.

The detector of the present invention preferably has self-propulsion, thus giving the detector the ability to acquire data while the objects of interest are stationary with respect to the detector as well as vice versa. The inclusion of predetermined detector output profiles adds the ability to make informed decisions (through successive algorithms) on detector information to minimize the number of innocent alarms. The present invention also preferably has the ability to have any of the threshold values of the detectors remotely monitored and controlled. The ability to automatically transfer the collected information (including but not limited to cargo ID number and GPS location) securely to remote locations where decisions regarding the disposition of the detected material can be made minimizes the number of support personnel required for system operation. Instructions can also be transmitted to the detector of the present invention from a remote location, thus removing any influence which the objects of interest or persons associated with the objects of interest may have over an operator who is physically present with the detector.

The present invention preferably captures data as well as other measurements (e.g., physical) from objects of interest, particularly from bulk cargo that is arranged in a variety of configurations including but not limited to (single-row, double-row, multi-rows, stacked cargo, mixed cargo, etc.). The same detection applies to measuring radiation or other information emanating or derived from objects of interest in locations that are not amenable to the installation and investment of fixed portals.

The present invention captures the relevant data either by passing the detector system over the objects to be inspected or by passing the objects of interest through the detector. The application locations for the present invention preferably include but are not limited to:
U.S. and foreign ports and megaports, with multiple deployment configurations inside port boundaries and anywhere cargo containers or bulk cargo containers are handled, including rail cars of any type that arrive or leave ports. The system seamlessly integrates into port operations without changing the traffic patterns of cargo handling equipment.
Airport cargo and baggage as it is loaded aboard passenger, cargo, or mixed passenger/cargo transport airplanes.
Rail yards where various types of rail cars, transporting either containers or bulk cargo or mixed cargo, are either stationary or moving.
Access locations to military installations, industrial installations (including nuclear power plants) or entrances to other government and public buildings that need to be protected and/or any locations within the boundaries of these facilities. In this case, the present invention is optionally designed with radiation-transparent material enclosures so as to hide it from view of users (i.e., the present invention is optionally enclosed within demountable partitions around its footprint, sides, and top elements to make it look like a portable, thick-wall transportable building with wide open entry and exit passageways.
Container storage facilities, including tractor trailers or truck depots or stops at or before border crossing points; with same enclosure features to conceal its detectors, frame, top and any other on-board systems from view if needed.
Access and egress points at stadiums, sport facilities, concert halls, or any entry to a building or facility.
Any locations where large or small cargo containers must pass through inspection gates such as entrance to freeways/highways, truck weigh stations and/or toll booths and/or bridges or tunnels; with same enclosure features to conceal its detectors, frame, top and any other on-board systems from view if needed.

The data acquisition and transmission capabilities of the present invention preferably include on-board processing and/or remote, encoded, non-processed data transmission to remote locations via radio frequency (“RF”) and by satellite through the use of antennas or other means known to those skilled in the art. All radiation detection measurements and other passive detector measurements are preferably processed on board with tamper-proof software and hardware and have the option of being sent remotely from the platforms via RF to remote, centralized, command, decision centers.

The mobile platform system of the present invention can also optionally include data acquisition and transmission to remote; secure locations either by use of analog or digital/numeric signals. The present invention also optionally possesses the ability to read the cargo container ID number and its geographical position through a GPS system, as well as any other identification information that is desired.

The present invention is preferably a positionably mobile, versatile system which has high-sensitivity as well as an intelligent detector (including but not limited to a radiation detector), and the ability to be deployed to points of need. The present invention preferably includes: a motorized or non-motorized structural platform; any number and/or type of detector(s) (including but not limited to radiation/or other active and/or passive detectors); and data collection systems capable detectors and of intelligently processing radiation detection or other physical, chemical or biological information at the point of need; video imaging systems to record pictures or photographs and cargo identification number and location; on-board data acquisition systems to capture cargo ID number electronically and reconstruct image; monitoring and control systems to ensure tamper-free detection threshold set-points; signal and lighting systems; and dedicated communication systems to send collected information to remote, secure locations including transmission via satellite to centralized stations where informed decisions regarding cargo disposition can be made.

With the ability to transmit data to a remote and secure location, the present invention enables persons removed from the site to make decisions regarding the items passing through the detector(s) of the present invention in real time. It is further preferable that a remote user be able to transmit data back to the detector(s) of the present invention which either directly or indirectly controls operation of one or more of the detector(s) of the present invention. As such, a remote person can preferably adjust the detector parameters if unexpected data is received or if the object of interest is otherwise suspicious. This enables a user to obtain a more detailed and accurate scan of cargo when needed.

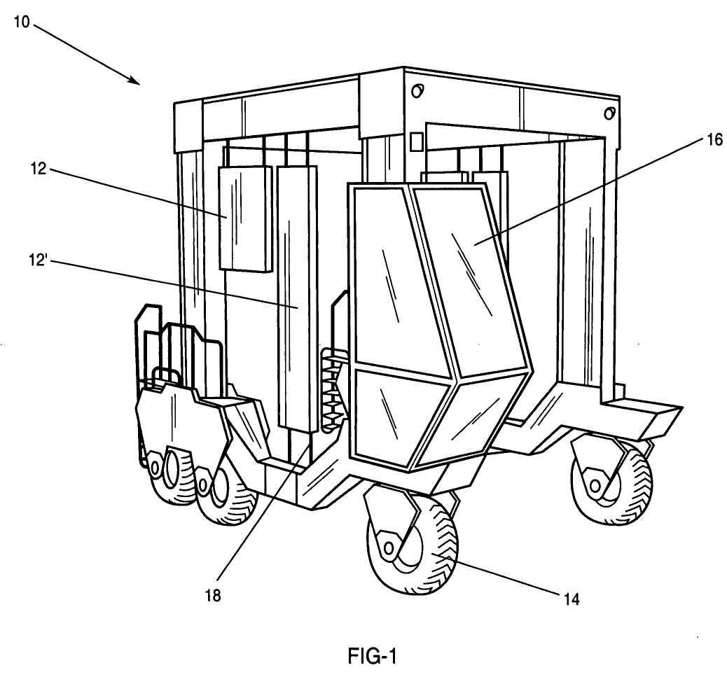

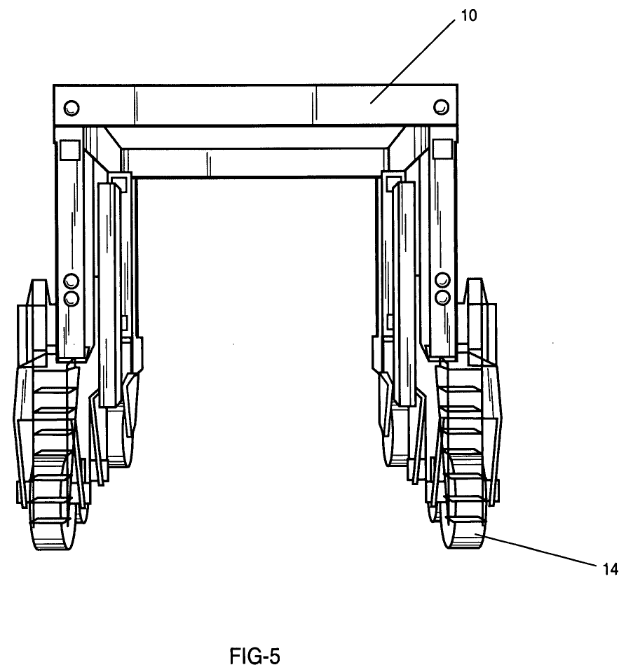

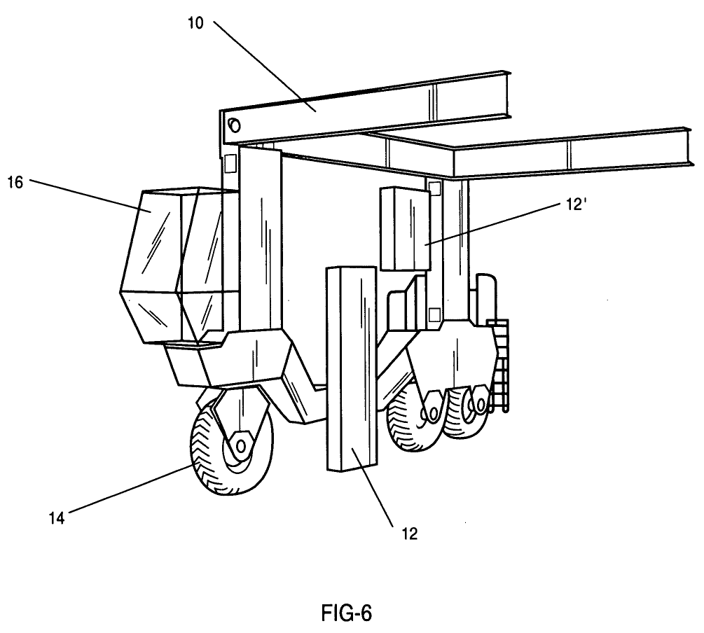

The preferred embodiment of the present invention is illustrated in the drawings. As shown in FIG. 1-6, structural platform 10 detects objects of interest and preferably straddles or surrounds at least two sides of the objects of interest which pass therethrough. Platform 10 may have any variety of shapes, including but not limited to an inverted U-shape, half-dome shape, dual inverted U-shape, or multiple inverted U-shapes to service one or more lanes simultaneously. The present invention also preferably has the ability to capture measurements, data and/or readings from detectors 12, 12′ disposed on platform 10. Although not essential, each platform 10 is preferably mounted on wheels 14. Platform 10 are made mobile either by being towed by an external driving mechanism, such as small industrial tractors or carts, which are themselves powered in any manner known to those skilled in the art, or by the addition of motors and/or engines which can be powered by electricity, batteries, internal combustion, hydraulic, pneumatic, or any combination of these as well as any other manner known to those skilled in the art. FIGS. 1 and 6 show an operator station 16 for moving or controlling platform 10.

Platform 10 is preferably expandable in height and/or width to accommodate varying sizes of containers or objects of interest. This expansion may be accomplished by sliding beams, adding sections, or any other means of expansion known in the art.

Detectors 12, 12′ are preferably movable by one or more movable devices 18. Movable devices include and are not limited to slides, gears, worm gears, valves, jacks, cranks, and any other movable devices, apparatuses, structures, or elements which are communicably attached to platform 10 and which impart movement to detectors 12, 12′. Detectors 12, 12′ preferably travel up or down or side-to-side, depending on the desired position. Although movable devices capable of imparting movement can be used, it is preferable to use one or more pneumatic devices, one or more hydraulic devices, an internal combustion engine, one or more electric motors, and/or combinations of these. Further, although not preferred, movable devices can be a hand crank mechanism or other manually operated apparatus which causes detectors 12, 12′ to move (i.e. gears, jacks, a hand-pulley, holes with pegs, etc.). As such, detectors 12, 12′ can be adjusted by an operator such that detectors 12, 12′ scan a particular area.

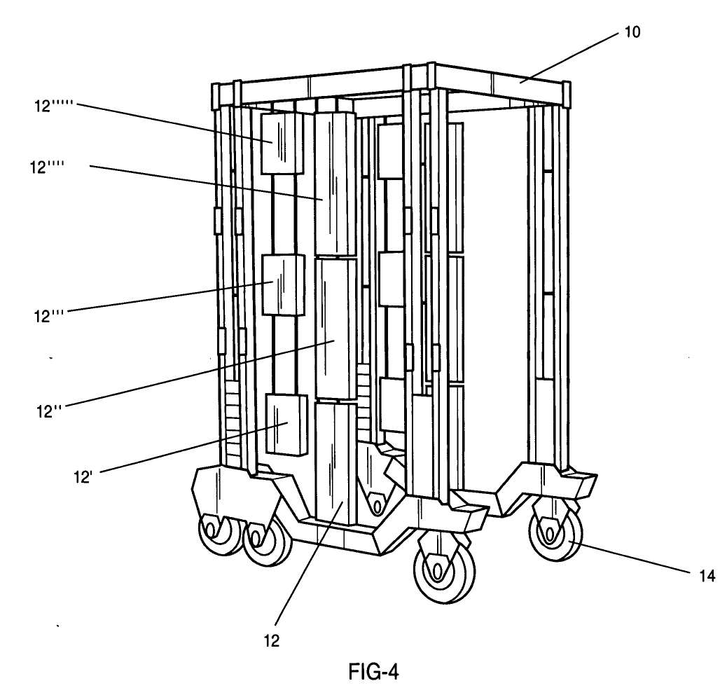

FIGS. 1, 2, 4, 6, and 9-10 show platform 10 provided with a plurality of detectors 12, 12′. 12″, 12′″, 12″″, 12′″″. In this embodiment, platform 10 preferably has an internal opening of sufficient height to allow a stack or side-by-side arrangement of standard shipping containers to pass therethrough. In this embodiment, platform 10 preferably has detectors 12 disposed on each side of platform 10 which substantially align with each shipping container when such containers are stacked or arranged multiple units high or wide. For example, platform 10 can have an opening of sufficient size to allow a stack of two, three, and even four containers to pass therethrough (see FIG. 4 which shows twelve detectors 12 to detect a stack of three containers) with detectors preferably substantially aligning with a predetermined portion of an external side of each container. While desirable results can be obtained without providing for adjustment of each of these detectors, it is preferable that each of the several detectors be movable with respect to the ground, in the vertical and/or horizontal axes.

Towed structural platforms, the simplest and least expensive embodiment of the present invention, preferably incorporate at least one pair of wheels to enable the platform to turn with a minimum of zero radius or a maximum turning radius equal to the width of a two-lane road for mid-size platforms or larger for more bulky and wider, multiple-gate platforms. Optional designs of the structural platforms optionally enable zero-radius turning (“ZRT”) to enhance maneuverability. The ZRT features can be achieved through electrical, electromechanical, or other means known to those skilled in the art. Motorized platforms preferably include the same features with the addition of an operator station, which can be open or enclosed, to position or operate components of the mobile platform. The operator station may include detector output information including optional operator decision equipment if required, such as remote-control. Soft tires are preferably used when a smoother ride is preferred. Industrial tires and wheels are preferably used where the terrain is substantially rough.

The external overall dimensions of the mobile platforms vary depending on the applications for which they are deployed. In its smaller application, the minimum mobile platform height may be less than approximately two meters, while in its largest application it can be higher than approximately 18 meters. In its smaller application, the width is preferably less than one meter. In its largest application the width can be wider than approximately 18 meters. In its smaller application, the minimum mobile platform length is preferably approximately 1.5 m. In its largest application the minimum mobile platform length can be as long as approximately 30 m. The range of weights of such platforms can vary from approximately 200 kg to 20 (metric) tons. The range of dimensions specified above span cargo heights ranging from less than approximately one meter to approximately several meters high. As such, the detector(s) of the present invention can be used to simultaneously scan cargo containers stacked from one high to four high, the maximum allowable in most container storage areas. However, should cargo be stacked even higher than four containers, the present invention can be modified to accommodate this stacking. Thus, large embodiments of the present invention can be used for sea-port or river barge port applications.

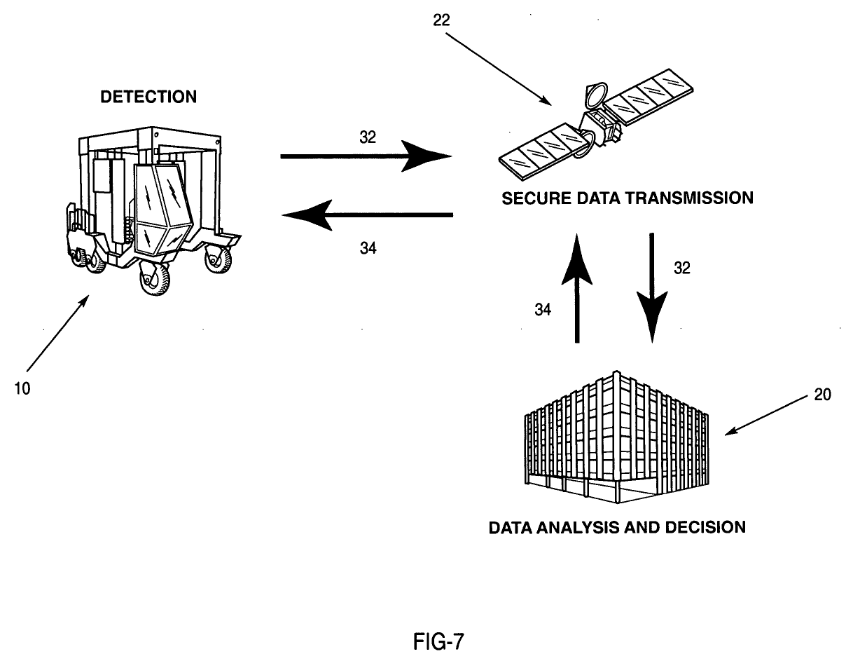

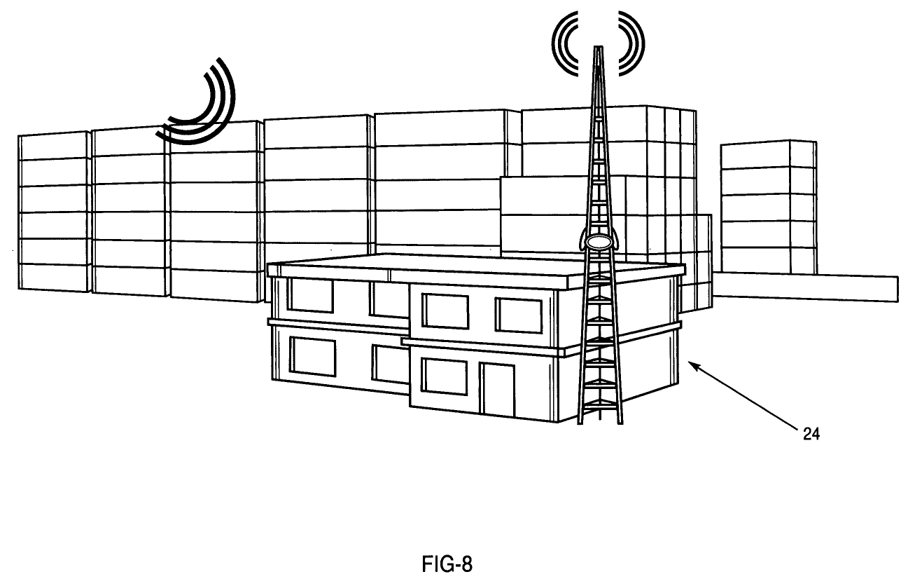

Remote location data processing 20 is preferably provided (see FIG. 7-8) although the present invention is capable of providing desirable results when structural platform 10 lacks the ability to transmit data to and receive instructions from a remote location. Data from platform 10 is sent 32, such as by satellite 22, or other means known in the art, to remote location 20. The data is then analyzed, viewed or processed at remote location 20. Instructions can be sent 34 from remote location 20 to platform 10 which adjusts or otherwise controls various functions of platform 10 or detectors 12. For example, if questionable data is received by remote location 20, persons or machines (e.g. computers) at remote location 20 can remotely send instructions to automatically adjust the sensitivity or threshold of detectors 20 on platform 10 or platform 10 itself. Although remote location 20 may reside near platform 10, remote location 20 may be distances of miles from platform 10. For instance, a cargo port could be located in a foreign country and remote location 20 could be located in the United States, between platform 10 and remote location 20 where the communication occurs via satellite 22. FIG. 8 shows data acquisition station 24 at the location of platform 10, which sends 32 and receives 34 information (see FIG. 7).

In one embodiment, remote location 20 obtains data about a particular location and then uses that data to make platforms 10 intelligent. As an example, if it is known that a particular cargo port or other area has certain radiation or other activity, detectors 12 can be pre-set or made intelligent, over time, to become more and more accurate for detection. The new data can then be transmitted to remote location 20, a databank developed, and then the data used to further program or automate the detectors 12 or platforms 10.

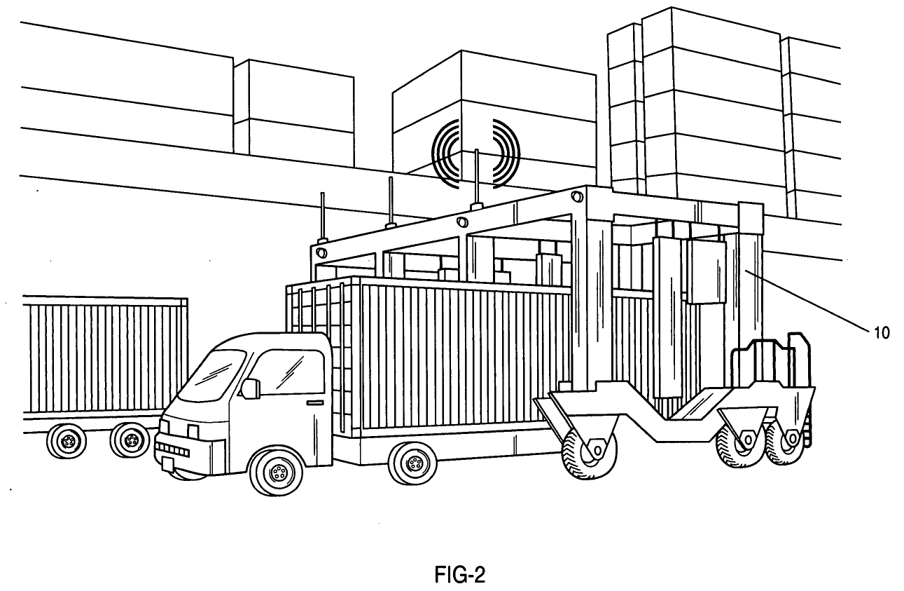

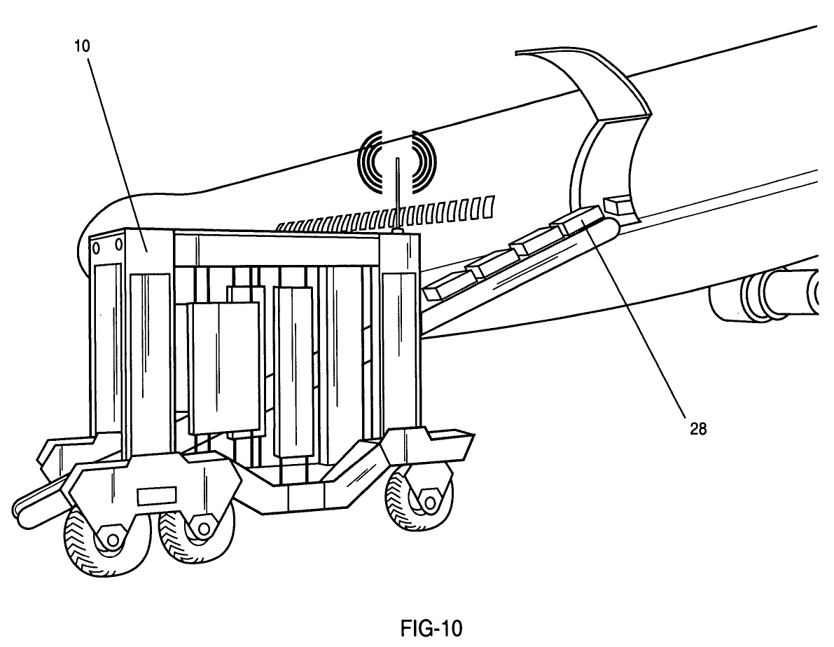

In all cases of deployment, the system preferably has the smallest or minimum footprint relative to the application where it is being used to enable it not to intrude into the working space of people and equipment. For example, in ports, the system preferably “straddles” the width of a tractor trailer but preferably does not exceed the width of a one-lane road where the tractor trailers are required to drive through. This enables several mobile platforms to be parked next to each other (or alternatively be attached to each other so as to form a multi-lane, one unit system such as illustrated in FIGS. 2, 3 and 6), or one platform within the width of each lane, below large ship-to-shore cranes that pick up or unload cargo containers or bulk cargo containers from ocean-going container vessels. The platforms' footprints enable them to be a seamless part of the container handling systems without affecting the flow or traffic pattern of tractor trailers or other handling equipment picking up or unloading cargo/bulk-cargo containers. The narrow footprint gives these mobile platforms outstanding performance in terms of detection sensitivity because of the proximity to the potential sources hidden in the moving cargo. This results in a lower detection threshold which is an important attribute in the detection of small amounts of smuggled materials, such as Special Nuclear Materials (“SNM”) and/or Radiological Dispersion Devices (“RDD”). For airport applications, minimum footprint enables mobile detection platforms to be parked next to cargo bays, thus straddling baggage conveyor belts (see FIG. 10) without interfering with the work of the baggage handler who needs access to the conveyor belt.

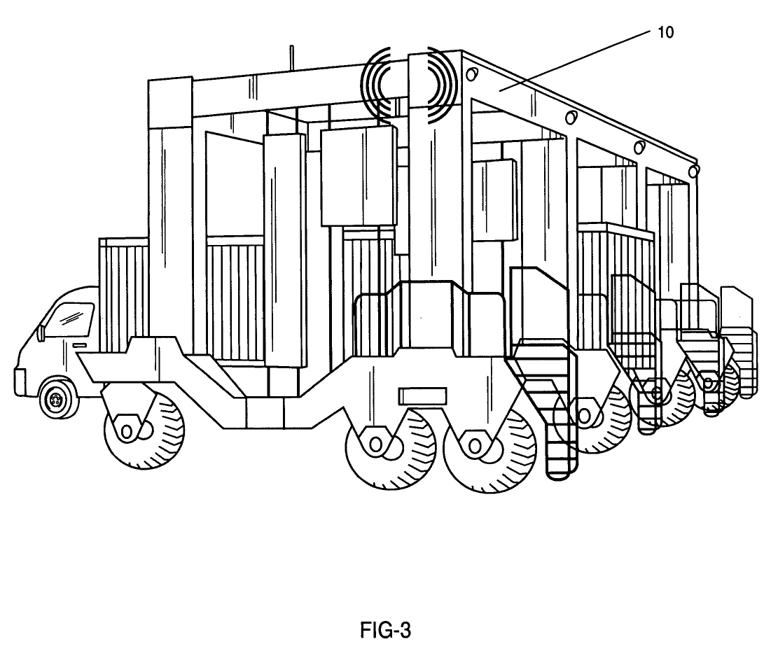

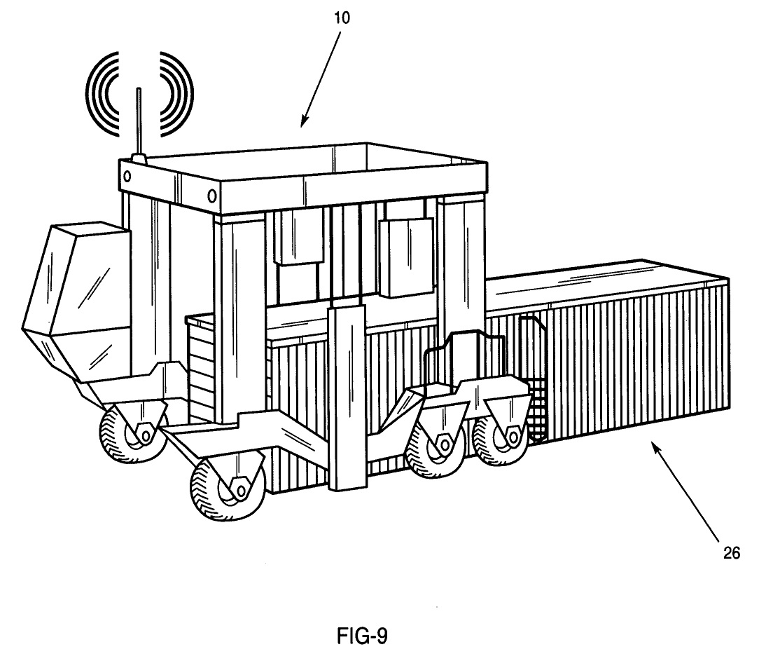

FIGS. 2 and 3 show a truck or trailer that drives through the platforms. FIG. 9 shows the platform moving over a container.

The structural platform of the present invention may be built from any type of structural material, including but not limited to various types of metals, metal alloys, composite materials, injection molded plastics and combinations thereof. Fabrication may include but is not limited to extruded elements, forged elements, cast elements or a combination thereof, and may be welded, riveted, bolted, or otherwise connected in any manner known in the art. The fabrication techniques for metal alloys, composite materials or injection molded plastic incorporate any number of methods including epoxy bonding, baked and unbaked.

Some of the detection equipment may be integrated into the structure of the platform. For example, radiation detectors, (e.g. helium-3 gas and filament) may be integrated into the sleeved columns of a platform made through molded plastic injection. In such cases, detectors have the dual functions of structural integrity and radiation detection.

Both motorized and towed platforms include all the necessary structural support features for any kinds, types, shapes and forms of radiation systems and/or other passive detector systems mounted in any combinations required for the specific applications. The platform also preferably supports within the footprint of its structure any type of analog or digital/numeric video and lighting system including LEDs and a wide array of data acquisition and communication systems including RF and satellite transmission equipment.

All of the above listed hardware may be mounted on the mobile structural platform by a combination of active or passive shock protection, vibration isolation and damping systems to protect it from shocks and vibrations during service. The vibration protection and damping systems may include and are not limited to any number of materials ranging from springs (coil or leaf), shock absorbers (including gas shocks), rubber, and synthetic or natural elastomer or polymer isolator materials.

The system of the present invention functions with any types/kinds of detectors or active passive detector systems, either as individual detectors, systems or in combination.

The system is inclusive of the data acquisition inherent to each type of detector including screening and data analysis algorithms. These algorithms preferably have the ability to differentiate between the energy levels of the emitted particles to produce, radiation profiles, identification of the object of interest, a particular radioisotope emitted by an object of interest, (be it special nuclear materials (“SNM”), or other hazardous isotopes of interest), illicit drug, physical, chemical or biological substance, or any other item to be detected. The screening algorithms preferably singly, or in combination, form the basis of the independent decision capabilities that the present invention is capable of providing. For radiation detectors, these types of radioisotope identification detectors and their software are referred to as radioisotope systems (“RIS”).

The present invention preferably has the ability to position any of the selected detectors vertically to configure to the exact height of the cargo being scanned and the ability to mount large detector arrays that cover the entire height of the cargo being scanned to maximize the solid angle and thus the data that reaches the detectors. For radiation, a large solid angle preferably provides more accurate measurements because of the ability to capture into the detectors a larger fraction of the spectra emitted by the source(s). The present invention preferably has the ability to remotely monitor and control the detection threshold of the detectors to prevent any tampering of the equipment.

The present invention preferably has the ability to perform redundant measurements, preferably using drive-through lanes. For radiation detectors, this detection could be from plastic detectors, helium tubes and from the RIS if these are mounted in combination. This allows for multiple redundant screenings that directly contribute to the intelligent, progressively more refined screenings designed to minimize the number of innocent alarms. Conversely, if only RIS are mounted on the platforms, the systems are designed to screen the radioisotope of interest using drive-through only at the driving speed specified.

The system may include outfitting several kinds/types of other passive or active detector systems, for example and not limited to detecting the thermal signature of shielded and unshielded SNM. This information serves to further discriminate the materials of interest.

Depending on the type of detectors ultimately used, since the present invention can be dispatched to a point of need where objects of interest are passing, the present invention preferably has the ability to constantly monitor the items of interest, even when they are continuously moving, thus providing a minimum of disruption to the flow of traffic or persons and/or objects.

Thus, the present invention is useful for any area that has traffic from vehicles or persons, in which flow is important. As an example, the platforms can be placed at a cargo port or any other detection area of interest. As a vehicle arrives to drop off or pick up containers, it would drive down the traffic lane and through the platform for detection. Without stopping (or stopping only for a brief period) at the platform, the object of interest (e.g. a container) would be scanned or subjected to the detector(s). If the detector detected a problem situation, it would signal to the driver to proceed to a separate holding area or a subsequent detector. The subsequent detector could be of a higher sensitivity or different threshold. If the detector detected no problem, it would signal to the driver to proceed to its desired location. Preferably, there would be a drive-through or walk-through situation, where no stopping is required. For busy areas, multiple platforms would be stationed at multiple traffic lanes. These platforms are preferably movable to and positionable at desired locations.

In the preferred embodiment, with drive-through or walk-through capabilities, e.g. using advanced spectroscopy detector systems, robust on-board data analysis system and remote secure communications, the present invention provides first level, robust radiation screening of containers, cargo, pedestrians or other objects of interest where needed without any impact on throughput.

The detector system uses positional, motorized, high sensitivity radiation detectors capable of detecting hazardous isotopes in a variety of cargo configurations (including stacking arrangements or multi-lanes) and surrounding materials. Moving on horizontal or new horizontal surfaces, the system can be deployed exactly at the point of need, even when these locations change on short notice.

The system has the ability to acquire radiation information emitted from single rows of object(s) from at least two sides and a top side at very close distances; collecting and processing radiation measurements with a high degree of sensitivity and accuracy; the ability to either acquire radiation data while the object(s) are moving with respect to the detector or vice-versa;
(d) the ability to make informed decisions (through successive algorithms) on radiation information to minimize the number of false alarms; (e) the ability to protect the radiation detection thresholds from being tampered; and (f) the ability to automatically transfer the collected information (including cargo video and digital streams and GPS location) securely to secure, remote locations where final decisions regarding the disposition of the detected material can be made.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above and/or in the attachments, and of the corresponding application(s), are hereby incorporated by reference.

1. A detecting apparatus comprising:
a remote location capable of receiving data and transmitting instructions; and
a positionable structural support comprising:
at least one detector disposed on said structural support, wherein data from said at least one detector is transmitted to said remote location and wherein instructions are transmitted from said remote location to said structural support; and
an opening for passing at least one object of interest therethrough.

2. The apparatus of claim 1 wherein said instructions cause adjustment of said structural support.

3. The apparatus of claim 1 wherein said instructions cause adjustment of said at least one detector.

4. The apparatus of claim 3 wherein said adjustment is performed manually or automatically.

5. The apparatus of claim 3 wherein said adjustment comprises a sensitivity or threshold adjustment.

6. The apparatus of claim 1 wherein said structural support is moveable.

7. The apparatus of claim 1 wherein said instructions enable intelligence of said structural support or said at least one detector.

8. The apparatus of claim 1 wherein the object of interest is a container.

9. The apparatus of claim 1 further comprising a data acquisition system.

10. The apparatus of claim 9 wherein said data acquisition system comprises at least one algorithm.

11. The apparatus of claim 1 wherein said at least one detector comprises at least one detector selected from the group consisting of active detectors, passive detectors and combinations thereof.

12. The apparatus of claim 11 wherein said at least one detector comprises at least one radiation detector.

13. The apparatus of claim 1 capable of accommodating one or more traffic lanes.

14. The apparatus of claim 1 wherein said remote location is in another country.

15. A method for detecting an object of interest comprising the steps of:
positioning a structural support comprising at least one detector disposed on the structural support;
passing the object of interest therethrough;
detecting the object of interest;
transmitting data from the structural support to a remote location; and
transmitting instructions from the remote location to the structural support.

16. The method of claim 15 wherein the step of transmitting the instructions further comprises the step of adjusting the structural support based on the instructions.

17. The method of claim 16 comprising adjusting at least one detector.

18. The method of claim 17 comprising automatically or manually adjusting at least one detector.

19. The method of claim 16 comprising adjusting sensitivity or threshold of at least one detector.

20. The method of claim 15 further comprising the step of moving the structural support.

21. The method of claim 15 further comprising the step of enabling intelligence of the structural support by the instructions.

22. The method of claim 15 wherein the object of interest is a container.

23. The method of claim 15 further comprising the step of acquiring data.

24. The method of claim 23 wherein said the step of acquiring data comprises using at least one algorithm.

25. The method of claim 15 wherein the at least one detector comprises at least one detector selected from the group consisting of active detectors, passive detectors and combinations thereof.

26. The method of claim 25 wherein the at least one detector comprises at least one radiation detector.

27. The method of claim 15 accommodating one or more traffic lanes.

28. The method of claim 15 wherein the remote location is in another country.
